(19) United States
(12) Patent Application Publication
(10) Pub. No.: US 2014/0184070 A1
(43) Pub. Date: Jul. 3, 2014

(54) LUMINARIE

(71) Applicant: RADIANT OPTO-ELECTRONICS CORPORATION, Kaohsiung (TW)

(72) Inventors: Cheng-Lin Lu, Kaohsiung (TW); Nick Lin, Tainan City (TW); Ko-Yu Hsiao, Kaohsiung (TW)

(73) Assignee: Radiant Opto-Electronics Corporation, Kaohsiung (TW)

(21) Appl. No.: 13/889,356

(22) Filed: May 8, 2013

(30) Foreign Application Priority Data
Dec. 28, 2012 (TW) 101151052

(51) Int. Cl. F21V 23/00

(52) U.S. Cl. CPC F21V 23/005
USPC 315/85

(57) ABSTRACT

A luminaire is provided. The luminaire includes a housing, at least one light source, and a light control module. The housing has a cavity for embedding the light control module and another cavity for embedding the light sources. The light control module includes a current control unit, at least one switch unit, a process unit, and a printed circuit board. The current control unit is used to provide DC current. The at least one switch unit is used to enable the current control unit to selectively provide a DC current to the at least one light source in accordance with at least one switch unit control signal. The process unit is used to adjust the DC current outputted by the current control unit.

### RELATED APPLICATIONS

This application claims priority to Taiwan Application Serial Number 101151052, filed Dec. 28, 2012, which is herein incorporated by reference.

### BACKGROUND

1. Field of Invention

The present invention relates to a luminaire. More particularly, the present invention relates to a luminaire using DC current.

2. Description of Related Art

Lighting devices play an important role in human life, and may be applied in various areas such as in a building, in a vehicle, or on a decoration article. Lighting device is not only an illumination tool but has great impact on human daily life.

Common lighting devices include incandescent lamps, fluorescent lamps, light emitting diode (LED) lamps, etc. In a conventional incandescent lamp, electricity is conducted through tungsten filaments to generate light by high heat. However, such incandescent lamp consumes a lot of power, and hence a fluorescent lamp is becoming a substitute of incandescent lamp.

A fluorescent lamp generally applies high voltage on electrodes to emit electrons hitting mercury vapor atoms for generating ionization and excitation phenomena. When the mercury vapor atoms return to an original state from an excitation state, an electromagnetic wave of 253.7 nm in wavelength is emitted, wherein the wavelength of 253.7 nm is in an invisible light wavelength range. Thereafter, various fluorescent materials can be used to absorb and convert the electromagnetic wave into visible light, such that the fluorescent lamp may emit various colors of light in accordance with the fluorescent materials.

For achieving the goals of energy saving and environmental protection, a light-emitting diode (LED) module is developed. When a LED is under a proper forward voltage, electrons and holes are respectively injected to N and P terminals. Then, energy is released in the form of light when the electrons drop to a basic state from an excited state at the P/N junction, thereby enabling the LED to emit light.

A light-emitting diode (LED) has better lighting efficiency and longer life duration than the fluorescent lamp, and hence has better performance on energy-saving than the fluorescent lamps. The LED requires DC current to generate light, and hence a LED lamp generally includes an AC-to-DC converter inside for converting AC to DC current. In general, a common AC-to-DC converter is a switching type and is disposed on a luminaire for supplying DC power to a back-end circuit. Even with a better power conversion ratio, the switching inverter is bigger and has the worse EMI, causing LED lamps to have a larger size and complicated design to pass safety regulations. Further, the lifetime of LEDs is longer than that of other electronic elements within the AC-to-DC converter, such as the electrolytic capacitor. Therefore, if the AC-to-DC converter could be disposed outside, the luminaire shall have longer lifetime and the AC-to-DC converter shall be easier to maintain.

Therefore, there is a need to develop a luminaire which has lower EMI, longer lifetime, a smaller size, and is easier to maintain.

### SUMMARY

An aspect of the present invention is to provide a luminaire. The luminaire only uses an electronic device with lower EMI and a smaller size for providing electric power to light sources, so as to decrease the EMI and the size of the luminaire, and increase the lifetime of the luminaire.

According to an embodiment of the present invention, the luminaire includes a housing, at least one light source and a light control module. The housing has a light-source cavity and a control-module cavity. The at least one light source is disposed in the light-source cavity. The light control module is disposed in the control-module cavity, and is electrically connected to the at least one light source, thereby providing DC current to drive the at least one light source. The light control module includes a current control unit, at least one switch unit, a processing unit, and a circuit board. The current control unit is used for providing the DC current. The at least one switch unit is electrically connected to the at least one light source to enable the current control unit to selectively provide the DC current to at least one of the at least one light source in accordance with at least one switch unit control signal. The processing unit is electrically connected to the current control unit to adjust the DC current outputted by the current control unit. The circuit board is used for supporting the current control unit, the at least one switch unit, and the processing unit.

It can be understood from the foregoing descriptions that the luminaire of the embodiment of the present invention only uses a current control unit with lower EMI and a smaller size to provide electric power to light sources, and disposes an AC-to-DC modularized power supply outside the luminaire, thus decreasing the EMI and the size of the luminaire, and prolonging the lifetime of the luminaire.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic structural diagram of an edge-type luminaire in accordance with an embodiment of the present invention;

FIG. 1a is a schematic cross-sectional view of the luminaire viewed along a line A-A′ in FIG. 1;

FIG. 1b is a schematic functional block diagram of a light control module in accordance with an embodiment of the present invention;

FIG. 1c is a schematic side view of the light control module in accordance with an embodiment of the present invention;

FIG. 1d to FIG. 1h are schematic functional block diagrams of light control modules in accordance with respective embodiments of the present invention;

FIG. 2 is a schematic cross-sectional view of a direct-type luminaire in accordance with another embodiment of the present invention;

FIG. 3 is a schematic cross-sectional view of a direct-type luminaire in accordance with another embodiment of the present invention; and

FIG. 4 is a schematic cross-sectional view of structure of a direct-type luminaire in accordance with still another embodiment of the present invention,

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

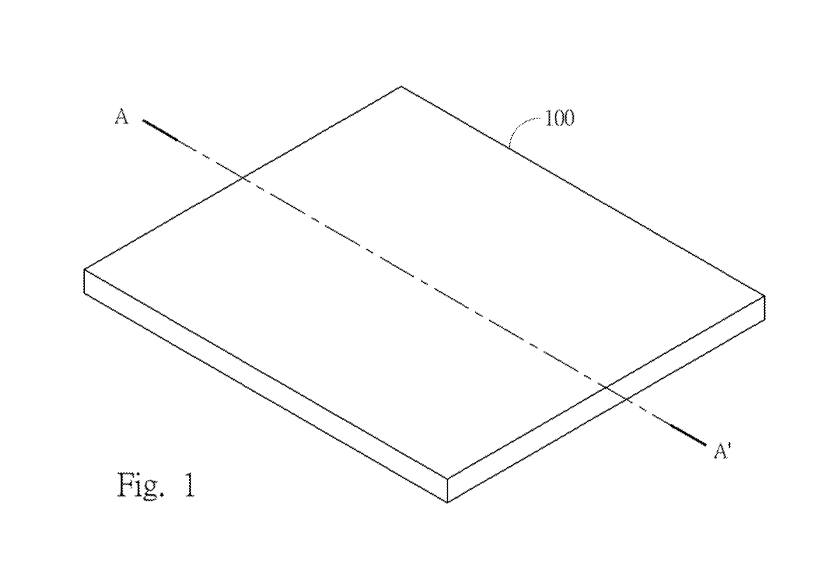

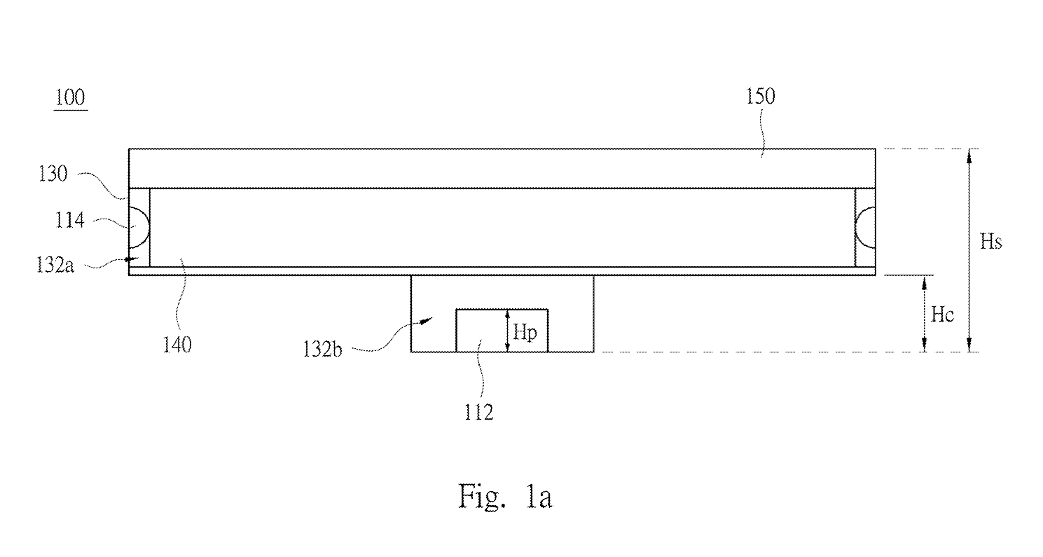

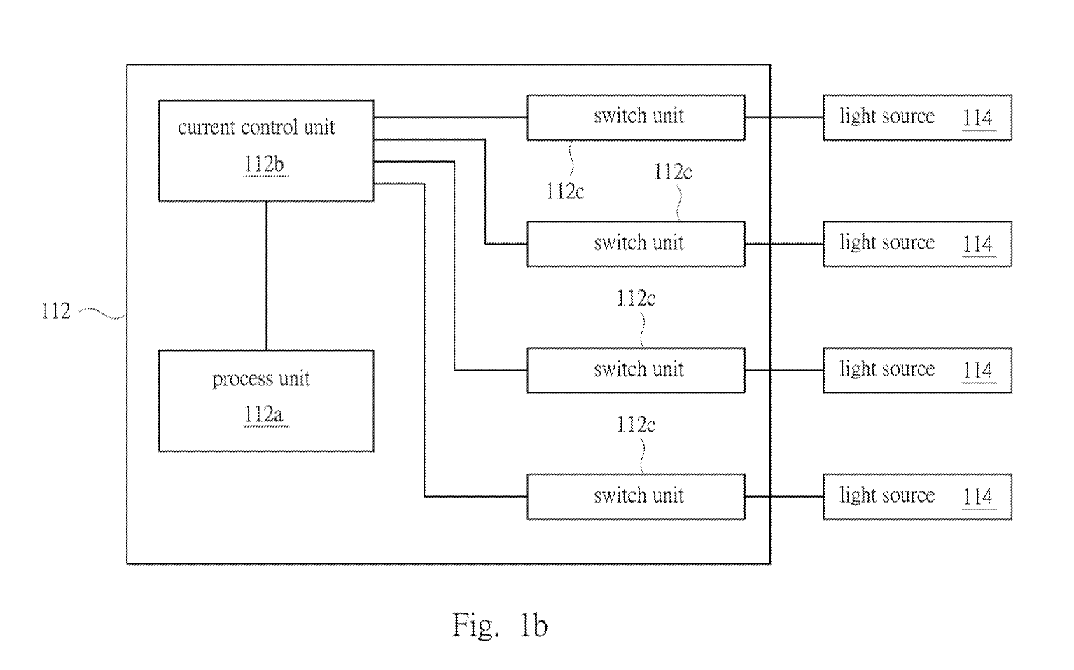

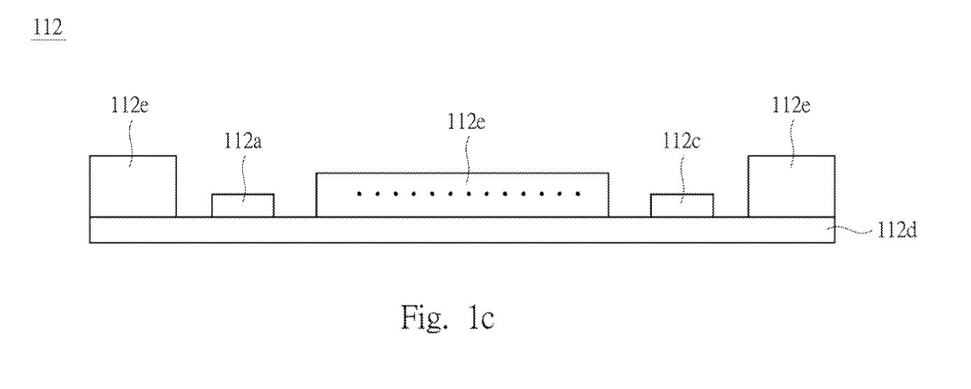

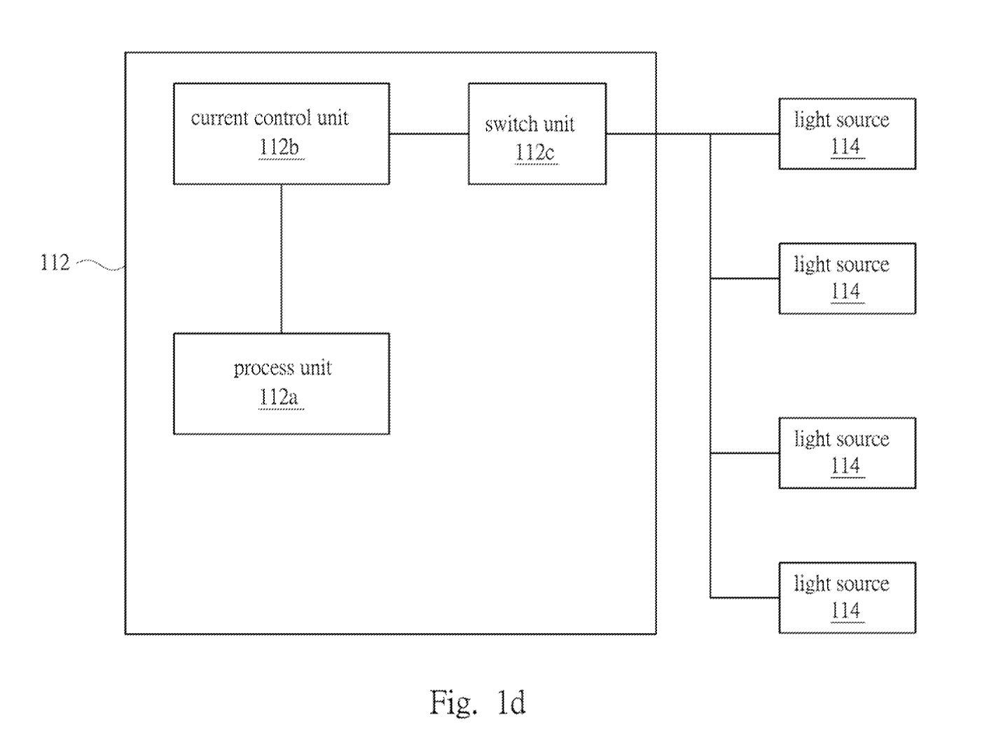

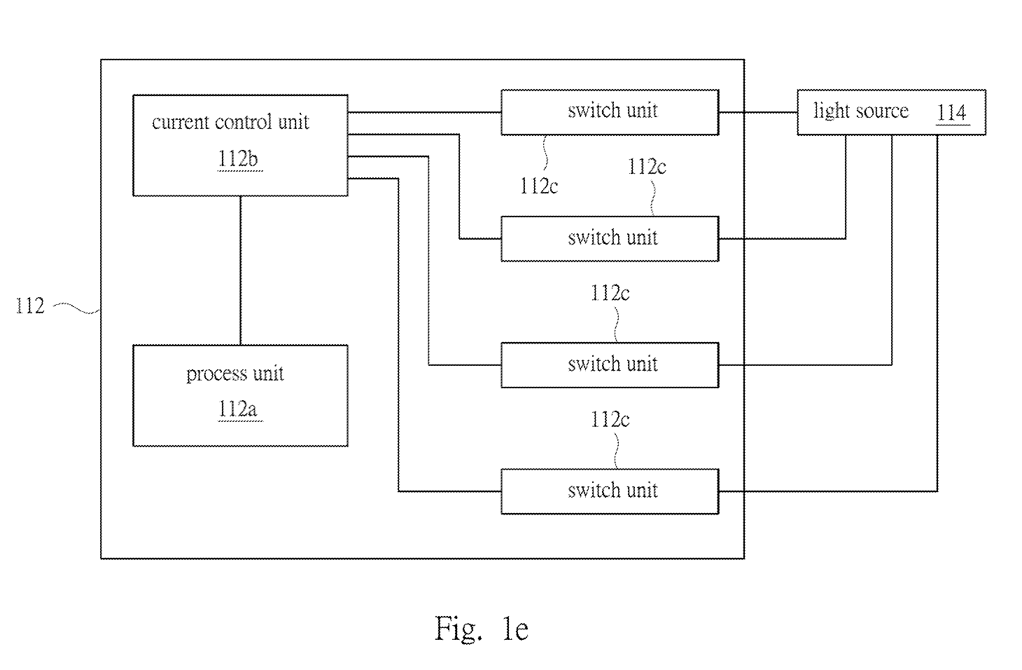

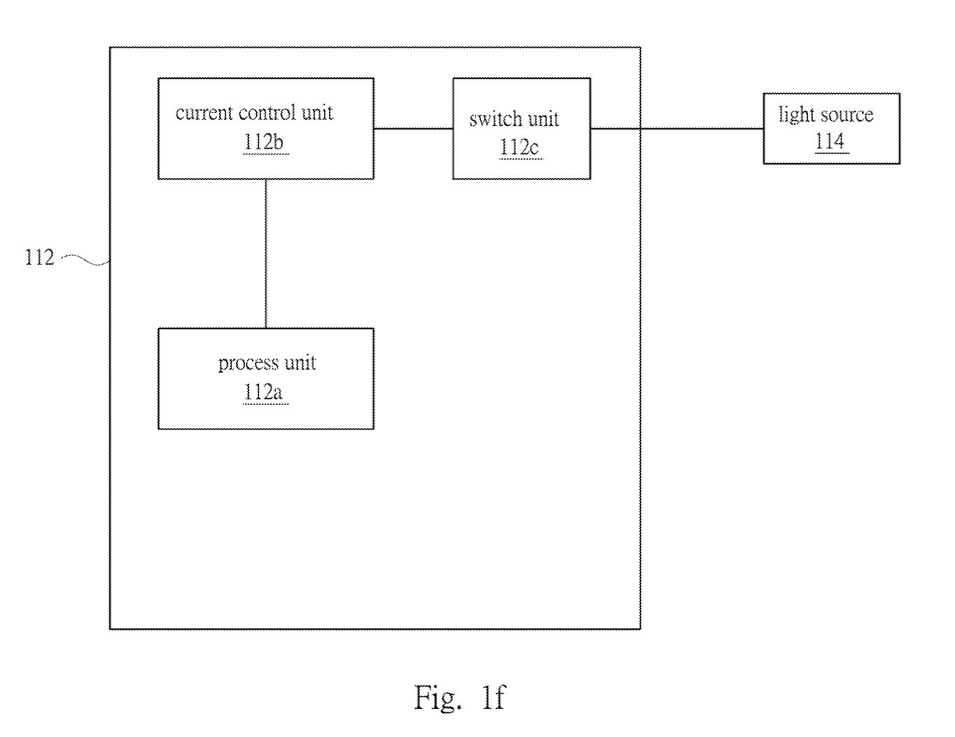

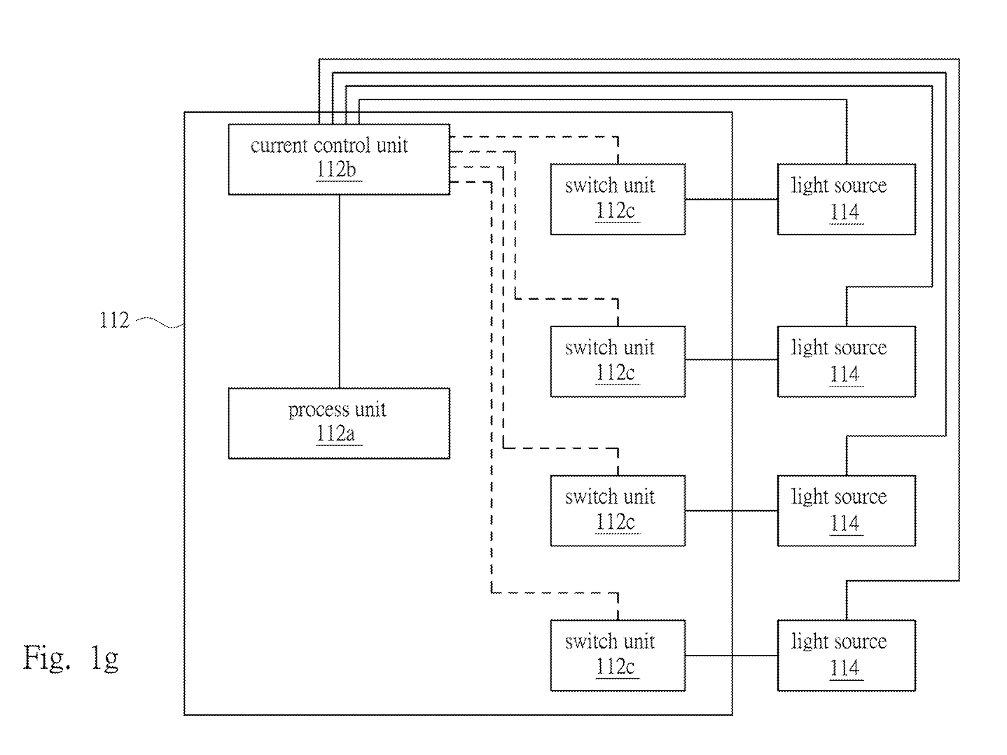

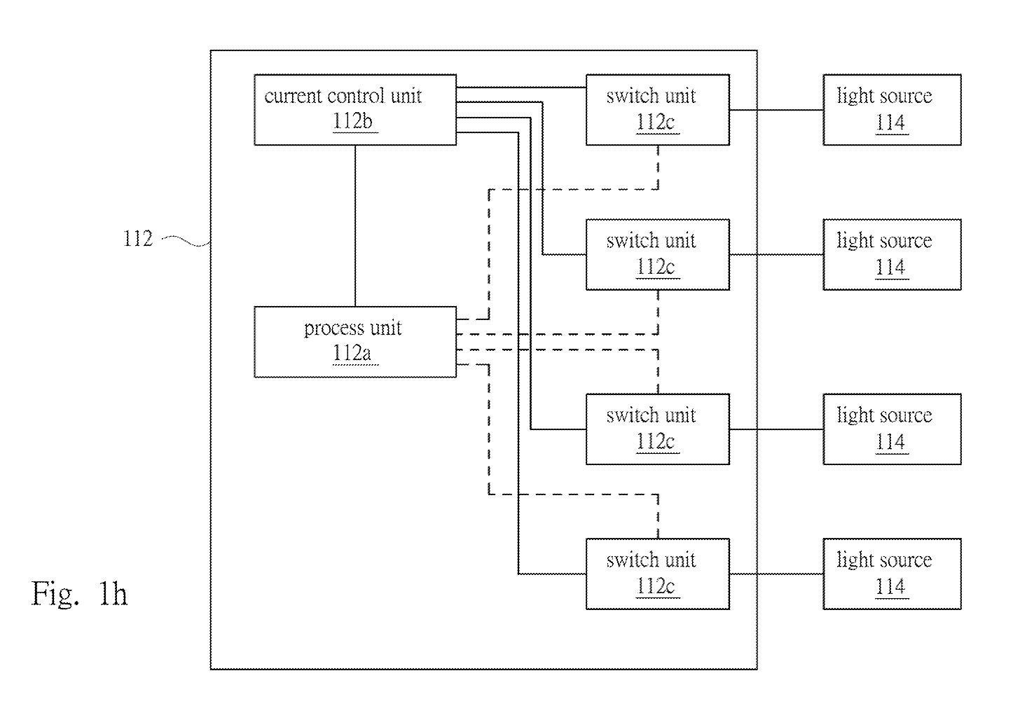

Referring to FIG. 1 and FIG. 1a simultaneously, FIG. 1 is a schematic structural diagram of an edge-type luminaire 100 in accordance with an embodiment of the present invention, and FIG. 1a is a schematic cross-sectional view of the luminaire 100 viewed along a line A-A′ in FIG. 1. The luminaire 100 includes a light control module 112, at least one light source 114, a housing 130, a light guide plate 140, and an optical film 150. In this embodiment, the housing 130 is a rectangular metal shell, and has a light-source cavity 132a and a control-module cavity 132b for embedding the light sources 114 and the light control module 112, respectively. In another embodiment, the housing 130 can be formed in another shape, such as a circular shape or a triangular shape, etc., and the material forming the housing 130 is not limited to metal. In addition, in this embodiment, the control-module cavity 132b is arranged at a bottom portion of the housing 130, but embodiments of the present invention are not limited thereto. In another embodiment of the present invention, the control-module cavity 132b can be arranged at a lateral side or a bottom side of the housing 130 without affecting light paths.

The light sources 114 are disposed in the light-source cavity 132a and resist against a sidewall of the housing 130 so as to provide light for illumination. In this embodiment, the light sources 114 are LEDs or LED bars, but not limited thereto. In another embodiment of the present invention, the light sources 114 can be other light sources using DC power sources. The light guide plate 140 is disposed in the light-source cavity 132a adjacent to the light sources 114 so as to guide the light of the light sources 114 outs of the luminaire 100. The optical film 150 is disposed above the light guide plate 140 to improve the illumination effect of the luminaire 100. In this embodiment, the optical film 150 is a diffusion plate, but is not limited thereto.

The light control module 112 is disposed in the control-module cavity 132b, and is electrically connected to the light sources 114 to control the operation state of the light sources 114. In order to make the luminaire 100 with a smaller size, a height Hs of the housing 130 is designed to be 2.3 cm, and a height Hc of the control-module cavity 132b is designed to be 1.0 cm. Besides considering the volume of the luminaire 100, the height design of the control-module cavity 132b also considers the stress exerted on the housing 130 when being formed.

In order to place the light control module 112 into the control-module cavity 132b, a thickness Hp of the light control module 112 has to be smaller than 1.0 cm. In order to achieve the thinning of the light control module 112, this embodiment provides the light control module 112 having a new architecture.

Referring to FIG. 1b and FIG. 1c simultaneously, FIG. 1b is a schematic functional block diagram of the light control module 112, and FIG. 1c is a schematic side view of the structure of the light control module 112. The light control module 112 includes a processing unit 112a, a current control unit 112b, at least one switch unit 112c, and a circuit board 112d, wherein the circuit board 112d is used for supporting the processing unit 112a, the current control unit 112b, and the switch units 112c. The light control module 112 is used for selectively providing a DC current to the light sources 114 so as to turn on all or part of the light sources 114. Hereinafter, functions of respective components of the light control module 112 are explained in detail.

The current control unit 112b is used for receiving a DC voltage source provided by an external power source through the power line 120, converting the DC voltage into a DC current supplied to the light sources 114, and providing switch control signals to the switch units 112c. The switch units 112c are electrically connected between the current control unit 112b and the light sources 114 for selectively providing the DC current to at least one of the light sources 114, wherein control terminals of the switch units 112c are electrically connected to the current control unit 112b so as to perform on/off operations in accordance with the switch control signals transmitted by the current control unit 112b.

The processing unit 112a is electrically connected to the current control unit 112b for determining the switch control signals outputted by the current control unit 112b and adjusting the value of the DC current outputted by the current control unit 112b in accordance with a user control signal. For example, when a user desires to turn on four light sources and adjust the brightness of the four light sources to maximum values, the user may use an electrical device (such as a remote controller) to transmit a control signal to the processing unit 112a. After receiving the user control signal, the processing unit 112a transmits signals to the current control unit 112b to determine values of the switch control signals, and then the current control unit 112b outputs the switch control signals to the switch units 112c to turn on four switch units so as to provide four current channels to four of the light sources 114, Meanwhile, the processing unit 112a also controls the current control unit 112b to adjust a value of the DC current to a maximum value so as to enable the four light sources 114 to emit light with maximum brightness.

In this embodiment, all elements of the light control module 112 are surface mounted devices (SMD). For example, to implement the actual circuit of the light control module 112, the processing unit 112a and the current control unit 112b can be integrated circuits with a TSSOP SSOP or MSOP package type, and the passive elements thereof can be chip resistors or chip capacitors, and the switch unit 112c can be a SOT, SMA, or TO series (for example TO-251) package.

In addition, all elements of the light control module 112 are surface mounted devices (SMD) without using the switch converter technique, and hence the light control module 112 does not require large-scale energy storage elements used for energy-conversion, and does not require high frequency pulse-width modulation (PWM) signals frequently applied for driving the switch units. Therefore, the light control module 112 has a very small total volume and low EMI advantageously. However, the light control module 112 also may use the switch converter technique to implement actual circuits.

According to the above descriptions, the luminaire 100 does not include an AC-to-DC converter, meaning that the light control module 112 of the luminaire 100 merely includes the processing unit 112a, the current control unit 112b, the switch units 112c, and other necessary passive elements (such as resistors and capacitors, etc.). Because the light control module 112 only uses the current control unit 112b for providing electric power, the electromagnetic disturbance (EMI) of the luminaire 100 can be greatly decreased.

In addition, because the light control module 112 of the embodiment of the present invention does not include an AC-to-DC converter, the height of the light control module 112 is greatly decreased. In this embodiment, the light control module 112, the maximum height of the light control module 112 including the circuit board 112d is 0.66 cm, but embodiments of the present invention are not limited thereto. The height of the light control module 112 can be further decreased due to a connection interface (such as a connector 112e) applied by the light control module 112. For example, if the light control module 112 only relies on wires to connect with external devices without using the connector 112e, the height of the light control module 112 can be further reduced to be smaller than 0.66 cm.

It is noted that, although the luminaire 100 has plural switch units 112c and plural light sources 114, embodiments of the present invention are not limited thereto. For example, in another embodiment, the corresponding relationship between the switch units 112c and the light sources 114 can be one-to-many or many-to-many, as shown in FIG. 1d and FIG. 1e. For another example, only one switch unit 112c and one light source 114 are included in the luminaire 100, as shown in FIG. 1f. In addition, the switch units 112c are not limited to being electrically connected between the current control unit 112b and the light sources 114, and the switch control signals are not limited to being provided by the current control unit 112b. For example, in another embodiment, as shown in FIG. 1g, the switch units 112c can be electrically connected between the light sources 114 and ground bias. For another example, as shown in FIG. 1h, the switch control signals can be provided by the processing unit 112a, wherein the dotted lines in FIG. 1g and FIG. 1h represent exemplary paths of the switch control signals.

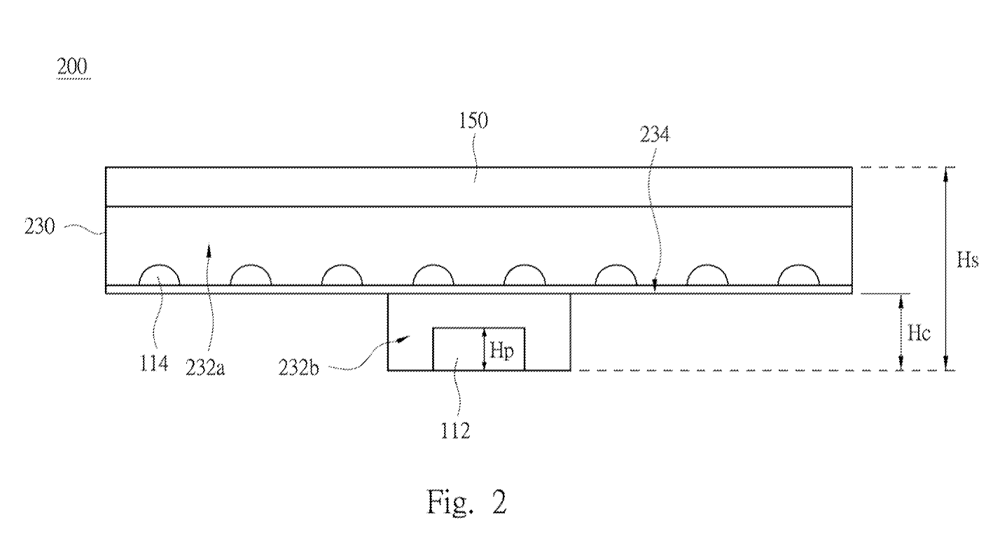

Referring to FIG. 2, FIG. 2 is a schematic cross-sectional view of a luminaire 200 in accordance with another embodiment of the present invention. The luminaire 200 is similar to the luminaire 100, but is different in that the luminaire 200 is a direct-type luminaire. The luminaire 200 includes the light sources 114, the light control module 112, and a housing 230, and the optical film 150.

Similar to the luminaire 100, the housing 230 of the luminaire 200 also has a light-source cavity 232a and a control-module cavity 232b. The light sources 114 are disposed in the light-source cavity 232a and located on a bottom 234 of the housing 230. The optical film 150 is disposed above the light sources 114 to improve the illumination effect of the luminaire 200. Because this embodiment is related to a direct-type luminaire, a height Hs of the housing 230 is designed to be 8.6 cm, and a height of the control-module cavity 232b is still smaller than 1.0 cm.

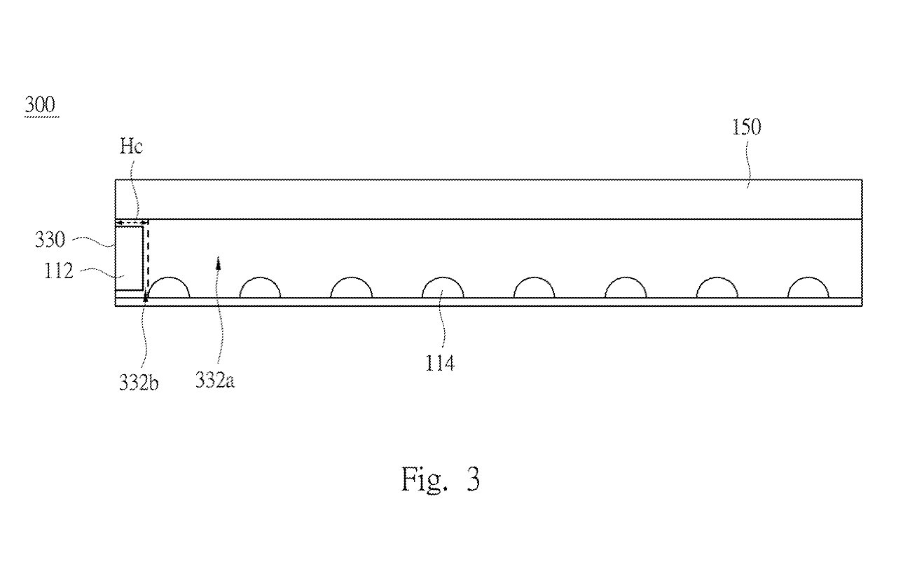

Referring to FIG. 3, FIG. 3 is a schematic cross-sectional view of a luminaire 300 in accordance with another embodiment of the present invention. The luminaire 300 is similar to the luminaire 100, but is different in that the luminaire 300 includes a housing 330, wherein a control-module cavity 332b of the housing 330 is located within a light-source cavity 332a of the housing 330, and the control-module cavity 332b is defined by the outermost light source 114.

In this embodiment, a distance between the outermost light source 114 and the sidewall of the housing 330 is marked as Hc, in which the light control module 112 is disposed on the sidewall of the housing 330 to avoid affecting light paths of the light sources 114.

In the luminaire 300 of the present invention, the light control module 112 and the light sources 114 are disposed in the same space. In comparison with the luminaire 100, the luminaire 300 does not need to provide an additional cavity for embedding the light control module 112, thus having a brief design.

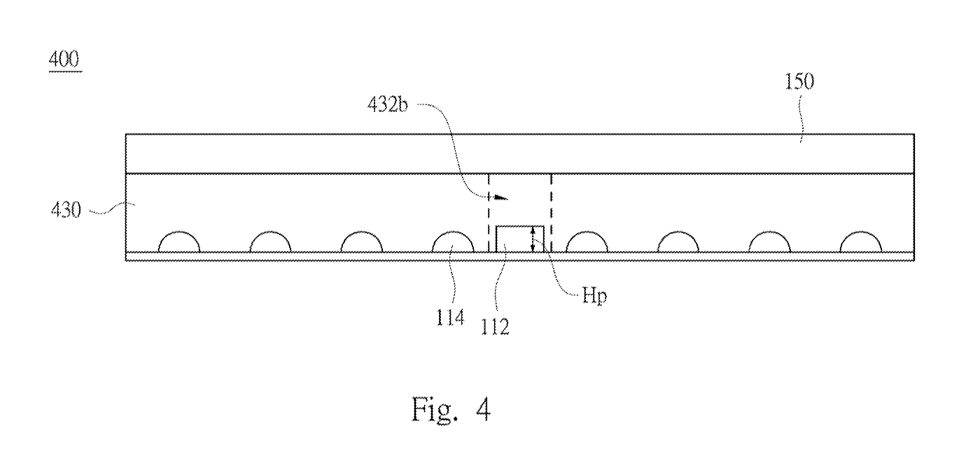

Referring to FIG. 4, FIG. 4 is a schematic cross-sectional view of structure of a luminaire 400 in accordance with another embodiment of the present invention. The luminaire 400 is similar to the luminaire 300, but is different in that a control-module cavity 432b of a housing 430 of the luminaire 400 is located between the light sources 114. In this embodiment, because a thickness Hp of the light control module 112 is smaller than 1.0 cm, the control-module cavity 432b can be properly designed between the light sources 114, thereby avoid affecting light paths of the light sources.

It can be known from the above descriptions that light the control module 112 and the light sources 114 can be disposed at any positions in the same space with a direct-type luminaire as long as the light control module 112 does not affect light paths of the light sources 114.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A luminaire, comprising:
a housing having a control-module cavity and a light-source cavity;
at least one light source disposed in the light-source cavity; and
a light control module disposed in the control-module cavity, and electrically connected to the at least one light source for providing DC current to drive the at least one light source, wherein the light control module comprises:
a current control unit used for providing DC current;
at least one switch unit electrically connected to the at least one light source to enable the current control unit for selectively providing DC current to at least one of the at least one light source in accordance with at least one switch unit control signal;
a processing unit electrically connected to the current control unit for adjusting the DC current outputted by the current control unit; and
a circuit board supporting the current control unit, the at least one switch unit, and the processing unit.

2. The luminaire of claim 1, wherein the at least one switch unit control signal is provided by the processing unit.

3. The luminaire of claim 1, wherein the at least one switch unit control signal is provided by the current control unit.

4. The luminaire of claim 1, wherein the at least one light source is at least one light-emitting diode.

5. The luminaire of claim 1, wherein package types of the current control unit and the processing unit are TSSOP, SSOP, or MSOP, and a package type of the at least one switch unit is SOT, SMA or TO series.

6. The luminaire of claim 1, wherein the luminaire is an edge-type luminaire.

7. The luminaire of claim 6, wherein a height of the housing is substantially equal to 2.3 cm, and a height of the light-source cavity is substantially smaller than 1 cm.

8. The luminaire of claim 1, wherein the luminaire is a direct-type luminaire.

9. The luminaire of claim 8, wherein a height of the housing is substantially equal to 8.6 cm, and a height of the light-source cavity is substantially smaller than 1 cm.
